(19) United States
(12) Patent Application Publication
(10) Pub. No.: US 2013/0264744 A1
(43) Pub. Date: Oct. 10, 2013

(54) PRODUCTION METHOD OF MOLD FOR NANOIMPRINTING

(71) Applicants: Satoru Ozawa, Otake-shi (JP); Katsuhiro Kojima, Otake-shi (JP)

(72) Inventors: Satoru Ozawa, Otake-shi (JP); Katsuhiro Kojima, Otake-shi (JP)

(73) Assignee: MITSUBISHI RAYON CO., LTD., Tokyo (JP)

(21) Appl. No.: 13/994,314

(22) PCT Filed: Jul. 13, 2012
(86) PCT No.: PCT/JP2012/067968

§ 371 Date: Jun. 14, 2013

(30) Foreign Application Priority Data
Jul. 19, 2011 (JP) 2011-157886

(51) Int. Cl. B29C 33/38

(52) U.S. Cl. CPC B29C 33/3842
USPC 264/293; 205/175; 205/324

(57) ABSTRACT

The present invention relates to a method for producing m (where, m is an integer of 1 or more) number of molds for nanoimprinting in which anodic alumina having a microrelief structure composed of a plurality of pores is formed on the surface of an aluminum base material, wherein the method has one or more anodic oxidation steps for anodically oxidizing an aluminum base material in an electrolytic solution for each of m number of aluminum base materials, and a difference (X−X₀) between the aluminum concentration X in the electrolytic solution and the aluminum concentration X₀ in the electrolytic solution immediately prior to the first anodic oxidation step of the first aluminum base material is 1000 ppm or less in all of the anodic oxidation steps.

### TECHNICAL FIELD

The present invention relates to method for producing a mold for nanoimprinting comprising the formation of anodic alumina having a microrelief structure composed of a plurality of pores on the surface of an aluminum base material.

The present application claims priority on the basis of Japanese Patent Application No. 2011-157886 filed in Japan on Jul. 19, 2011, the contents of which are incorporated herein by reference.

### BACKGROUND ART

Articles such as transparent films having a microrelief structure of a period equal to or less than the wavelength of visible light on the surface thereof are known to demonstrate reflection prevention effects, lotus effects and the like. In particular, a microrelief structure referred to as a moth eye structure is known to be an effective means for preventing reflection by continuously increasing refractive index from the refractive index of air to the refractive index of the article.

Known examples of methods for producing transparent films having a microrelief structure on the surface thereof include so-called nanoimprinting methods having the following steps (i) to (iii):

(i) a step for interposing an active energy beam-curable composition between a mold having an inverted structure of a microrelief structure on the surface thereof and a base material film serving as the body of the transparent film,

(ii) a step for obtaining a transparent film composed of the base material film and a curable resin layer by irradiating the active energy beam-curable composition with an active energy beam such as ultraviolet light to form a curable resin layer having a microrelief structure by curing the active energy beam-curable composition, and

(iii) a step for separating the transparent film and the mold.

In order to produce a transparent film having a microrelief structure by transferring the microrelief structure (inverted structure) of a mold in this manner, it is important to precisely form the microrelief structure of the mold. A mold production method has been reported that consists of forming anodic alumina having a microrelief structure composed of a plurality of pores on the surface of an aluminum base material by anodic oxidation of the aluminum base material in an electrolytic solution (Patent Documents 1 and 2).

### PRIOR ART DOCUMENTS

### Patent Documents

Patent Document 1: Japanese Unexamined Patent Application, First Publication No. 2009-241351
Patent Document 2: International Publication No. WO 2006/059686

### DISCLOSURE OF THE INVENTION

### Problems to be Solved by the Invention

However, even in the case of carrying out anodic oxidation using the same electrolytic solution and under the same conditions, the anodic alumina on the aluminum base material subsequently subjected to anodic oxidation may be thinner than the aluminum base material previously subjected to anodic oxidation. As a result, it may be difficult to impart the microrelief structure of the mold with a prescribed shape (designed shape).

The present invention provides a method that enables the production of a mold for nanoimprinting that has a microrelief structure of a prescribed shape.

### Means for Solving the Problems

The following findings were obtained by the inventors of the present invention as a result of conducting extensive studies.

When subjecting an aluminum base material to anodic oxidation in an electrolytic solution, aluminum elutes from the aluminum base material in the electrolytic solution. If the rise in aluminum concentration in the electrolytic solution becomes small, there is no effect on the shape of the microrelief structure of the mold. However, if the rise in aluminum concentration in the electrolytic solution becomes large, the anodically oxidized alumina becomes thin, and as a result thereof, it may be difficult to impart the microrelief structure of the mold with a prescribed shape (designed shape). A transparent film having a microrelief structure obtained by transferring the microrelief structure of the mold (inverted structure) is also unable to demonstrate prescribed performance.

The inventors of the present invention found that, by specifying an upper limit value for the rise in aluminum concentration in the electrolytic solution that has an effect on the shape of the microrelief structure of the mold and making the rise in aluminum concentration in the electrolytic solution to be equal to or less than that upper limit value, the microrelief structure of the mold can be imparted with a prescribed shape, while also discovering a method for easily measuring aluminum concentration in an electrolytic solution, thereby leading to completion of the present invention.

(1) A first aspect of the production method of a mold for nanoimprinting of the present invention is a method for producing m (where, m is an integer of 1 or more) number of molds for nanoimprinting, in which anodic alumina having a microrelief structure composed of a plurality of pores is formed on the surface of an aluminum base material, that has one or more anodic oxidation steps for anodically oxidizing an aluminum base material in an electrolytic solution for each of m number of aluminum base materials, and a difference (X−X₀) between the aluminum concentration X in the electrolytic solution and the aluminum concentration X₀ in the electrolytic solution immediately prior to the first anodic oxidation step of the first aluminum base material is 1000 ppm or less in all of the anodic oxidation steps.

(2) In (1) above, m is preferably an integer of 2 or more.

(3) In (1) or (2) above, the electrolytic solution is preferably an aqueous oxalic acid solution.

(4) In (3) above, the aluminum concentration in the electrolytic solution is preferably determined from the titrated amount of an aqueous alkaline solution in the flat portion of a titration curve that appears between a first equivalent point and a second equivalent point when the electrolytic solution has been titrated with the aqueous alkaline solution.

(5) In (4) above, a calibration curve is prepared in advance between an aluminum concentration X′ and a titrated amount Y′ of an aqueous alkaline solution in the flat portion of a titration curve that appears between a first equivalent point and a second equivalent point when having titrated an aqueous oxalic acid solution having an aluminum concentration X′ with an aqueous alkaline solution having an alkaline concentration Z, and the calibration curve is used to determine an aluminum concentration X in the electrolytic solution from a titrated amount Y of the aqueous alkaline solution in the flat portion of a titration curve that appears between a first equivalent point and a second equivalent point when the electrolytic solution has been titrated with an aqueous alkaline solution having an alkaline concentration Z.

(6) In any of (1) to (5) above, production of the mold for nanoimprinting is discontinued in case the difference (X−X₀) has exceeded 1000 ppm.

### Effects of the Invention

According to the production method of a mold for nanoimprinting of the present invention, a mold for nanoimprinting can be produced that has a microrelief structure of a prescribed shape.

### BRIEF DESCRIPTION OF THE DRAWINGS

FIG. 1 is a titration curve obtained by titrating an aqueous oxalic solution having an aluminum concentration of 0 ppm with a 0.1 N aqueous sodium hydroxide solution.

FIG. 2 is a titration curve obtained by titrating an aqueous oxalic solution having an aluminum concentration of 500 ppm with a 0.1 N aqueous sodium hydroxide solution.

FIG. 3 is a titration curve obtained by titrating an aqueous oxalic solution having an aluminum concentration of 1005 ppm with a 0.1 N aqueous sodium hydroxide solution.

FIG. 4 is a graph showing the relationship between the titrated amount of an aqueous sodium hydroxide solution in a flat portion and the aluminum concentration in an aqueous oxalic acid solution determined with an ICP emission spectrometric analyzer.

FIG. 5 is a cross-sectional view showing the production steps of a mold for nanoimprinting having anodic alumina on the surface thereof.

FIG. 6 is a scanning electron micrograph of a cross-section of an oxide film obtained in step (a) of Example 1.

FIG. 7 is a scanning electron micrograph of a cross-section of an oxide film obtained in step (a) of Example 2.

FIG. 8 is a scanning electron micrograph of a cross-section of an oxide film obtained in step (a) of Example 3.

FIG. 9 is a scanning electron micrograph of a cross-section of an oxide film obtained in step (a) of Example 4.

FIG. 10 is a scanning electron micrograph of a cross-section of an oxide film obtained in step (a) of Comparative Example 1.

### BEST MODE FOR CARRYING OUT THE INVENTION

The production method of a mold for nanoimprinting of the present invention (to also be simply referred to as the “mold”) has one or more anodic oxidation steps for anodically oxidizing an aluminum base material in an electrolytic solution for each of m (where, m is an integer of 1 or more) number of aluminum base materials. The production method preferably has 2 or more anodic oxidation steps from the viewpoint of forming pores of adequate depth. The production method may also have, for example, a step for removing an oxide film and a step for increasing the diameter of pores of the oxide film, as necessary, from the viewpoints of forming pores of a shape in which diameter continuously decreases from the openings thereof in the direction of depth with high regularity.

An oxide film (anodic alumina) having a plurality of pores on the surface of an aluminum base material is formed by anodically oxidizing the aluminum base material in an electrolytic solution.

When producing the mold, from the viewpoint of mold production cost, the electrolytic solution is preferably used repeatedly as many times as possible, or in other words, after having anodically oxidized the aluminum base material in the electrolytic solution, this electrolytic solution is preferably used to again anodically oxidize the same aluminum base material or anodically oxidize a different aluminum base material.

The number m of aluminum base materials may be 1 or 2 or more. From the viewpoint of producing a mold having a microrelief structure of a prescribed shape with good productivity, the number m of the aluminum base materials is preferably 2 or more, more preferably 10 or more and even more preferably 20 or more. The greater the number m of aluminum base materials the better, and there are no limitations on the upper limit thereof.

When anodically oxidizing the aluminum base material in the electrolytic solution, since aluminum ions elute into the electrolytic solution from the aluminum base material, although only in an extremely small amount, aluminum is contained in the electrolytic solution. The aluminum in the electrolytic solution as referred to here indicates, for example, aluminum ions, aluminum hydroxide, aluminum oxide or aluminum complex.

If the rise in aluminum concentration in the electrolytic solution is small, there is no significant effect on the shape of the microrelief structure of the mold. However, if the rise in aluminum concentration of the electrolytic solution is large, oxidation also progresses in the dissolved aluminum when a voltage is applied during anodic oxidation. In addition, aluminum and acid in the electrolytic solution form a salt or complex that causes a decrease in acid concentration in the electrolytic solution. Consequently, even if a prescribed voltage is applied, it becomes difficult for oxidation to proceed on the surface of the aluminum base material, and the oxide film formed on the surface of the aluminum base material becomes thin. As a result, it becomes difficult to impart a prescribed shape (designed shape) to the microrelief structure of the mold.

The degree of the rise in aluminum concentration in the electrolytic solution for which such phenomena do not occur, namely a difference (X−X₀) between the aluminum concentration X in the electrolytic solution and the aluminum concentration X₀ in the electrolytic solution immediately prior to the first anodic oxidation step of the first aluminum base material, is 1000 ppm or less, preferably 900 ppm or less and more preferably 800 or less. There are no particular limitations on the lower limit of X−X₀.

In the present invention, X−X₀ is 1000 ppm or less in all anodic oxidation steps. If X−X₀ is 1000 ppm or less, the thickness of the oxide film formed on each aluminum base material can be made to be a prescribed thickness (designed thickness). In the case of having two anodic oxidation steps for a single aluminum base material, the value of X−X₀ is 1000 ppm or less in each step. In addition, during the time the mold is manufactured, namely from immediately before the first anodic oxidation of the first aluminum base material to immediately after completion of anodic oxidation of the last aluminum base material, the value of X−X₀ is 1000 ppm or less, and the value of X−X₀ is also 1000 ppm or less while each anodic oxidation step is in progress.

Next, an explanation is provided of the case of producing two or more molds using the same electrolytic solution.

In the case of continuously producing two or more molds, even in the case aluminum is contained in the electrolytic solution and the progression of oxidation on the surface of the aluminum base material is slow, molds of the same quality can be produced continuously in the case the rate of progression of oxidation does not change. However, if the value of X−X₀ exceeds 1000 ppm, the rate of progression of oxidation changes considerably. Consequently, there is a considerable difference in quality between the first mold produced and the mold produced using an electrolytic solution in which X−X₀ has exceeded 1000 ppm even if produced using the same electrolytic solution and under the same conditions.

Furthermore, the “aluminum concentration X₀ in the electrolytic solution immediately prior to the first anodic oxidation step of the first aluminum base material” refers to the aluminum concentration in the electrolytic solution immediately before carrying out anodic oxidation on the initial (first) aluminum base material in the case of continuously anodically oxidizing two or more aluminum base materials using the electrolytic solution without replacing the electrolytic solution or readjusting the concentration thereof. In addition, in the case of having readjusted the concentration of aluminum and/or the concentration of the electrolytic solution by adding a highly concentrated electrolytic solution, the concentration of the electrolytic solution after adjustment is the “aluminum concentration X₀ in the electrolytic solution immediately prior to the first anodic oxidation step of the first aluminum base material”.

In the mold production method of the present invention, from the viewpoint of making the thickness of the oxide film formed on the surface of the aluminum base material to be a prescribed thickness, the aluminum concentration in the electrolytic solution is preferably determined immediately prior to initial anodic oxidation of the aluminum base material, and the aluminum concentration in the electrolytic solution is more preferably determined immediately prior to each time an aluminum base material is subjected to anodic oxidation. Moreover, the aluminum concentration in the electrolytic solution may also be determined during anodic oxidation of the aluminum base material.

The aluminum concentration in the electrolytic solution is normally determined using a technique such as atomic absorption or ICP emission spectrometric analysis. In the present invention, from the viewpoint of being able to easily determine the aluminum concentration in the electrolytic solution, the aluminum concentration in the electrolytic solution is preferably determined based on the change in a titration curve when the electrolytic solution has been titrated with an aqueous alkaline solution.

The following provides a detailed explanation of the case of using an aqueous oxalic acid solution for the electrolytic solution.

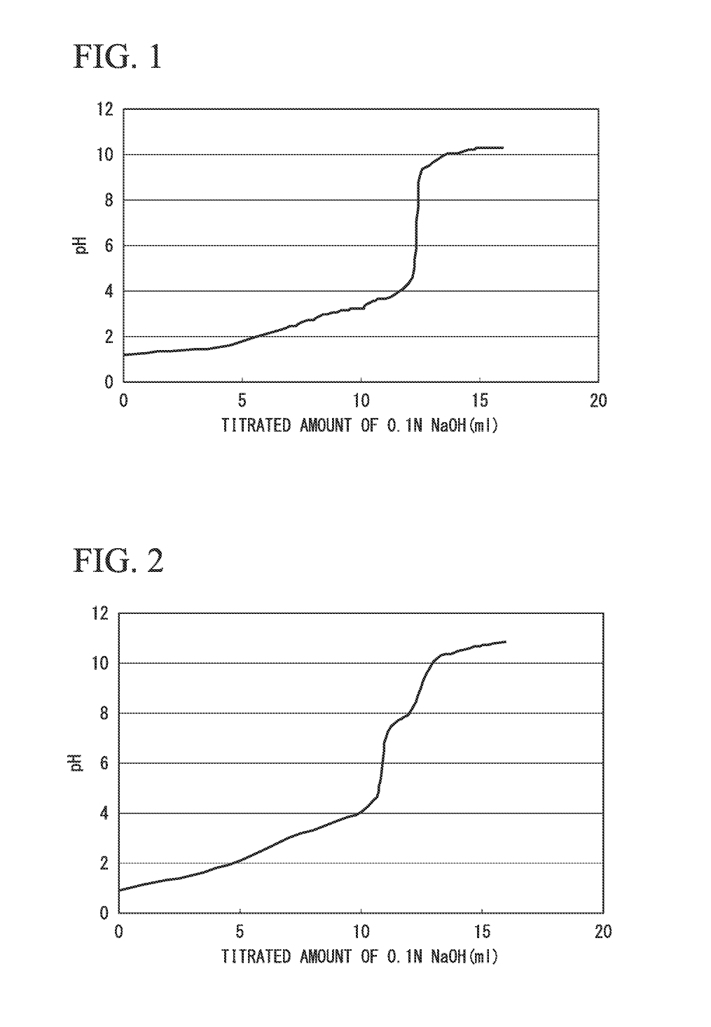

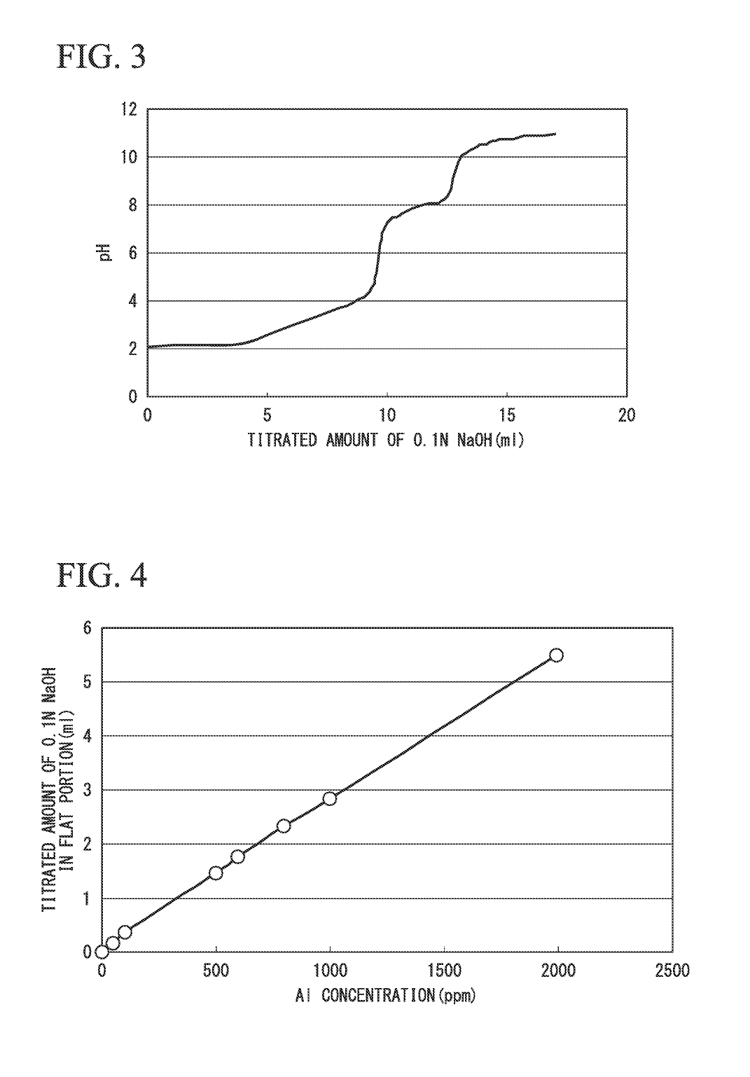

The concentration of oxalic acid is well known to be able to be determined by titration with an aqueous alkaline solution (such as an aqueous sodium hydroxide solution). An example of a titration curve obtained by titrating an aqueous oxalic acid solution with 0.1 N aqueous sodium hydroxide solution is shown in FIG. 1. On the other hand, titration curves obtained by titrating aqueous oxalic acid solutions containing 500 ppm and 1005 ppm of aluminum with 0.1 N aqueous sodium hydroxide solution are shown in FIGS. 2 and 3. A flat portion occurs where it is difficult for pH to increase even if additional aqueous sodium hydroxide solution is dropped in at a region of about pH 7 to 9 between a first equivalent point and a second equivalent point of the titration curve. In this flat portion, the oxidation of formula (1) indicated below is thought to proceed and result in the generation of tetrahydroxoaluminate ions.

Al³⁺+4OH→Al(OH)₄⁻ (1)

In actuality, the relationship between the molar concentration [OH] of hydroxyl groups as calculated from the titrated amount of sodium hydroxide in this flat portion and the molar concentration [Al] of aluminum in the aqueous oxalic acid solution as determined with an ICP emission spectrometric analyzer is represented by formula (2) shown below.

[Al]:[OH]=1:4 (2)

In this manner, the length of the flat portion (titrated amount of aqueous sodium hydroxide solution) is proportional to the aluminum concentration in the aqueous oxalic acid solution. Thus, aluminum concentration can be determined from the length of the flat portion.

Furthermore, the “titrated amount of aqueous alkaline solution in the flat portion” in the present invention refers to the amount of aqueous alkaline solution titrated from a first equivalent point to a second equivalent point of the titration curve.

FIG. 4 shows the relationship between the titrated amount of aqueous sodium hydroxide solution in a flat portion and the aluminum concentration in an aqueous oxalic acid solution determined with an ICP emission spectrometric analyzer. The titrated amount of aqueous sodium hydroxide solution and the aluminum concentration in the electrolytic solution are in a proportional relationship, and the aluminum concentration in the electrolytic solution can be more easily determined by using this relationship in the form of a calibration curve.

More specifically, aluminum concentration in the electrolytic solution is determined in the manner described below.

(i) The titrated amount Y′1 of an aqueous alkaline solution is determined in a flat portion that appears between a first equivalent point and a second equivalent point of a titration curve obtained by titrating an aqueous oxalic acid solution having a certain aluminum concentration X′1 with an aqueous alkaline solution having an alkaline concentration Z (of, for example, 0.1 N).

(ii) The titrated amount Y′2 to Y′n of an aqueous alkaline solution is determined in a flat portion by changing the aluminum concentration in the aqueous oxalic acid solution to X′2 to X′n and repeating the same procedure as (i) a total of n times.

(iii) The relationship between aluminum concentrations X′1 to X′n and the titrated amounts Y′1 to Y′n of the aqueous alkaline solution in the flat portion is plotted on a graph, and a calibration curve is prepared between the aluminum concentration X′ and the titrated amount Y′ of the aqueous alkaline solution in the flat portion.

(iv) The aluminum concentration X or X₀ in the electrolytic solution is then determined using this calibration curve from the titrated amount Y of the aqueous alkaline solution in the flat portion that appears between a first equivalent point and a second equivalent point of a titration curve when the electrolytic solution is titrated with the aqueous alkaline solution having an alkaline concentration Z (of, for example, 0.1 N).

In the mold production method of the present invention, from the viewpoint of effectively using expensive aluminum, mold production is preferably discontinued in the case the value of X−X₀ has exceeded 1000 ppm. After mold production has been discontinued, mold production is preferably resumed after having prepared an electrolytic solution in which the value of X−X₀ is 1000 ppm or less.

In the mold production method of the present invention, the anodic oxidation step is preferably controlled so that the value of X−X₀ is 1000 ppm or less, more preferably 900 ppm or less, and even more preferably 800 ppm or less.

The following provides an explanation of a specific method for producing a mold in which anodic alumina having a microrelief structure composed of a plurality of pores is formed on the surface of an aluminum base material.

An example of a mold production method is a method having the following steps (a) to (f):

(a) a step for forming an oxide film on the surface of an aluminum base material by anodically oxidizing the aluminum base material in an electrolytic solution at a constant voltage;

(b) a step for forming anodic oxidation pore generation sites on the surface of the aluminum base material by removing the oxide film;

(c) a step for forming an oxide film having pores at the pore generation sites by repeating anodic oxidation of the aluminum base material in the electrolytic solution,

(d) a step for increasing the diameter of the pores,

(e) a step for repeating anodic oxidation in the electrolytic solution following step (d), and

(f) a step for obtaining a mold in which anodic alumina having a plurality of pores is formed on the surface of the aluminum base material by repeating steps (d) and (e).

Step (a):

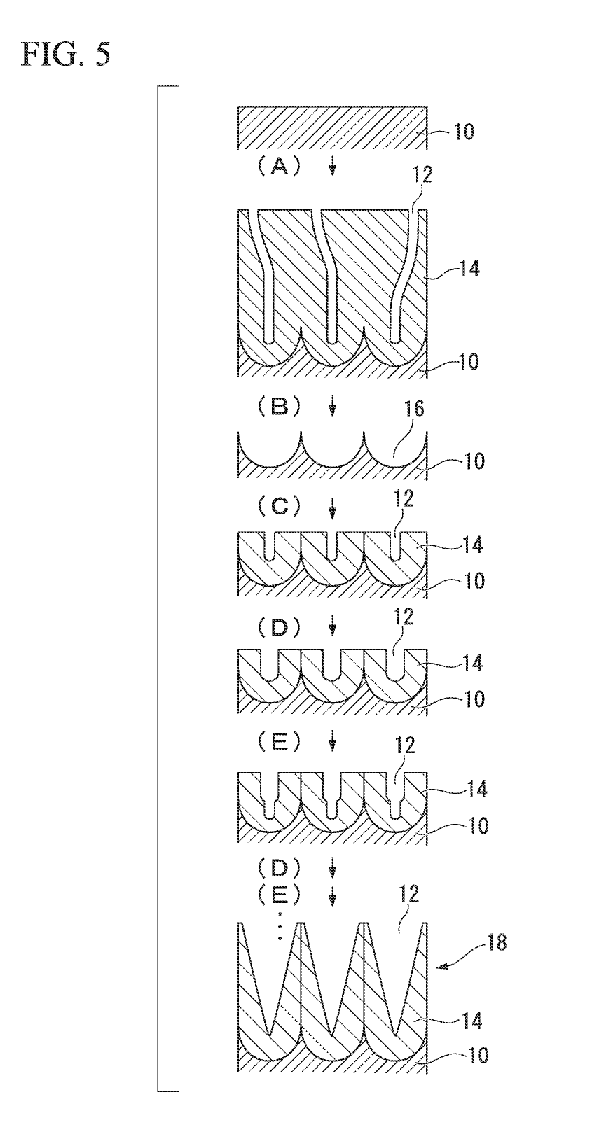

As shown in FIG. 5, an oxide film 14 having pores 12 is formed when an aluminum base material 10 is subjected to anodic oxidation.

Examples of the shape of the aluminum base material include a roll, cylinder, plate and sheet.

In addition, the aluminum base material is preferably polished by mechanical polishing, fabric polishing, chemical polishing or electrolytic polishing (etching) and the like in order to smooth the surface thereof. In addition, since oil used when processing the aluminum base material to a prescribed shape may be adhered to the aluminum base material, the aluminum base material is preferably degreased prior to anodic oxidation.

The purity of the aluminum is preferably 99% by weight or more, more preferably 99.5% by weight or more and particularly preferably 99.8% by weight or more. If the purity of the aluminum is low, a relief structure may be formed of a size that causes scattering of visible light due to segregation of impurities during anodic oxidation, or the regularity of the pores obtained by anodic oxidation may decrease.

Examples of the electrolytic solution include aqueous oxalic acid solution, aqueous sulfuric acid solution and aqueous phosphoric acid solution.

Case of Using Aqueous Oxalic Acid Solution for Electrolytic Solution:

The oxalic acid concentration is preferably 0.7 M or less. If the oxalic acid concentration exceeds 0.7 M, current values become excessively large and the surface of the oxide film may become rough.

Anodic alumina having highly regular pores separated by an average interval of 100 nm can be obtained when using a formation voltage of 30 V to 60 V. Regularity tends to decrease if the formation voltage is higher than or lower than this range.

The temperature of the electrolytic solution is preferably 60° C. or lower and more preferably 45° C. or lower. If the temperature of the electrolytic solution is higher than 60° C., a phenomenon referred to as “scorching” may occur causing destruction of the pores or disturbing the regularity of the pores due to melting of the surface.

Case of Using Aqueous Sulfuric Acid Solution for Electrolytic Solution:

The sulfuric acid concentration is preferably 0.7 M or less. If the sulfuric acid concentration exceeds 0.7 M, current values become excessively high and it may not be possible to maintain a constant voltage.

Anodic alumina having highly regular pores separated by an average interval of 63 nm can be obtained when using a formation voltage of 25 V to 30 V. Regularity tends to decrease if the formation voltage is higher than or lower than this range.

The temperature of the electrolytic solution is preferably 30° C. or lower and more preferably 20° C. or lower. If the temperature of the electrolytic solution is higher than 30° C., a phenomenon referred to as “scorching” may occur causing destruction of the pores or disturbing the regularity of the pores due to melting of the surface.

Step (b):

As shown in FIG. 5, regularity of the pores can be improved by temporarily removing the oxide film 14 to form anodic oxidation pore generation sites. Furthermore, in cases when such a high degree of regularity is not required, at least a portion of the oxide film 14 may be removed or the subsequently described step (d) may be carried out after step (a).

An example of a method used to remove the oxide film consists of removing the oxide film by dissolving in a solution that selectively dissolves the oxide film without dissolving aluminum. An example of such a solution is a mixed solution of chromic acid and phosphoric acid.

Step (c):

As shown in FIG. 5, the oxide film 14 having cylindrical pores 12 is formed when the aluminum base material 10 from which the oxide film has been removed is again subjected to anodic oxidation.

Anodic oxidation is carried out under the same conditions as step (a). Deeper pores can be obtained the longer the duration of anodic oxidation.

Step (d):

As shown in FIG. 5, treatment for increasing the diameter of the pores 12 (to be referred to as pore diameter enlargement treatment) is carried out. This pore diameter enlargement treatment is a treatment for increasing the diameter of pores obtained by anodic oxidation by immersing in a solution that dissolves the oxide film. An example of such a solution is an aqueous phosphoric acid solution having a concentration of about 5% by weight.

Pore diameter becomes larger the longer the duration of pore diameter enlargement treatment.

Step (e):

As shown in FIG. 5, the cylindrical pores 12 of a small diameter that extend downward from the bottoms of the cylindrical pores 12 are further formed when anodic oxidation is repeated.

Anodic oxidation may be carried out under the same conditions as step (a) or the conditions may be suitably changed. For example, deeper pores can be obtained the longer the duration of anodic oxidation.

Step (f):

As shown in FIG. 5, the oxide film 14 having pores 12 of a shape such that the diameter thereof continuously decreases from the openings thereof in the direction of depth is formed by repeating the pore diameter enlargement treatment of step (d) and the anodic oxidation of step (e), and a mold body 18 is obtained having anodic alumina (aluminum porous oxide film (alumite)) on the surface of the aluminum base material 10. Production is preferably ended with step (d).

The number of repetitions is preferably a total of 3 times or more and more preferably 5 times or more. Since pore diameter decreases discontinuously if the number of repetitions is 2 times or less, reflectance reducing effects of the microrelief structure (moth eye structure) formed using anodic alumina having such pores is inadequate.

Examples of the shape of the pores 12 include a roughly conical shape, pyramidal shape and cylindrical shape, and a shape, such as a conical shape or pyramidal shape, in which pore cross-sectional area in a direction perpendicular to the direction of depth continuously decreases from the uppermost surface in the direction of depth, is preferable.

The average interval between the pores 12 is an interval equal to or less than the wavelength of visible light, namely 400 nm or less. The average interval between the pores 12 is preferably 20 nm or less.

The average interval between the pores 12 is determined by measuring the interval between adjacent pores 12 (distance from the center of a pore 12 to the center of an adjacent pore 12) at 50 locations by observing with an electron microscope, followed by taking the average of those measurements.

In the case of an average interval of 100 nm, the depth of the pores 12 is preferably 80 nm to 500 nm, more preferably 120 nm to 400 nm and particularly preferably 150 nm to 300 nm.

The depth of the pores 12 is a value obtained by measuring the distance between the lowermost portion of the pores 12 and the uppermost portion of the protrusion present between the pores 12 by observing with an electron microscope.

The aspect ratio (pore depth/average interval between pores) of the pores 12 is preferably 0.8 to 5.0, more preferably 1.2 to 4.0 and particularly preferably 1.5 to 3.0.

Other Steps:

In the present invention, although the mold body 18 obtained in step (f) may be used directly as a mold, the surface of the mold body 18 on the side on which the microrelief structure is formed may be treated with a mold release agent (external mold release agent).

The mold release agent preferably has a functional group capable of forming a chemical bond with the anodic alumina of the aluminum base material. Specific examples of mold release agents include silicon resin, fluorine resin and fluorine compounds, and from the viewpoint of superior mold release and the viewpoint of adhesion to the mold body, a compound having a silanol group or hydrolyzable silyl group is preferable, while a fluorine compound having a hydrolyzable silyl group is particularly preferable.

Examples of commercially available products of fluorine compounds having a hydrolyzable silyl group include fluoroalkylsilane, “KBM-7803” manufactured by Shin-Etsu Chemical Industries Co., Ltd., members of the “Optool” series manufactured by Daikin Industries Ltd., and “Novec EGC-1720” manufactured by Sumitomo 3M Ltd.

Examples of methods for treating with mold release agent include the following methods 1 and 2, and method 1 is particularly preferable from the viewpoint of being able to evenly treat the surface of the mold body on the side on which the microrelief structure is formed with mold release agent.

Method 1: Immersion of the mold body in a diluted solution of a mold release agent.

Method 2: Coating of a mold release agent or diluted solution thereof onto the surface of the mold body on the side on which the microrelief structure is formed.

A preferable example of Method 1 is a method having the following steps (g) to (k):

(g) step for washing the mold body with water;

(h) step for blowing air onto the mold body to remove water droplets adhered to the surface of the mold body;

(i) step for immersing the mold body in a dilute solution obtained by diluting a fluorine compound having a hydrolyzable silyl group with a solvent;

(j) step for slowly lifting out the immersed mold body from the solution; and

(k) step for drying the mold body.

Step (g):

Since chemicals used when forming the porous structure (such as aqueous phosphoric acid solution used during pore diameter enlargement treatment) and impurities (dust) and the like are adhered to the mold body, these are removed by washing with water.

Step (h):

Air is blown onto the mold body to nearly completely remove all visible water droplets.

Step (i):

A known solvent such as a fluorine-based solvent or alcohol-based solvent is used for the diluting solvent. A fluorine-based solvent is particularly preferable from the viewpoint of allowing uniform coating of an external mold release agent as a result of having suitable volatility and wettability. Examples of fluorine-based solvents include hydrofluoropolyether, perfluorohexane, perfluoromethylcyclohexane, perfluoro-1,3-dimethylcyclohexane and dichloropentafluoropropane.

The concentration of the fluorine compound having a hydrolyzable silyl group in the diluting solvent (100% by weight) is preferably 0.01% by weight to 0.2% by weight.

Immersion time is preferably 1 minute to 30 minutes.

Immersion temperature is preferably 0° C. to 50° C.

Step (j):

When lifting out the immersed mold body from the solution, the mold body is preferably lifted out at a constant speed using a motorized winch and the like to inhibit shaking during lifting. Coating unevenness can be reduced as a result thereof.

The lifting speed is preferably 1 mm/sec to 10 mm/sec.

Step (k):

In the step for drying the mold body, the mold body may be air-dried or may be dried by forced heating with a dryer and the like.

The drying temperature is preferably 30° C. to 150° C.

The drying time is preferably 5 minutes to 300 minutes.

Furthermore, treatment of the surface of the mold body with a mold release agent can be confirmed by measuring the water contact angle of the surface of the mold body. The water contact angle of the surface of the mold body treated with a mold release agent is preferably 60° or more and more preferably 90° or more. If the water contact angle is 60° or more, this indicates that the surface of the mold body has been adequately treated with the mold release agent and demonstrates satisfactory mold release.

In the mold production method of the present invention as explained thus far, since the value of X−X₀ is 1000 ppm or less, a mold of a prescribed shape (designed shape) can be precisely produced.

In addition, the aluminum concentration in the electrolytic solution can be easily determined by determining the aluminum concentration in the electrolytic solution from the titrated amount of an aqueous alkaline solution in a flat portion that appears between a first equivalent point and a second equivalent point of a titration curve obtained when the electrolytic solution is titrated with the aqueous alkaline solution.

### EXAMPLES

Although the following provides a more detailed explanation of the present invention through examples thereof, the present invention is not limited to these examples.

(Electron Microscope Observation)

A portion of an aluminum base material or mold body having an oxide film was scraped off, platina was vapor-deposited on a cross-section thereof for 1 minute, and the cross-section was observed under conditions of an acceleration voltage of 3.00 kV using a field emission scanning electron microscope (JSM-7400F, JEOL Ltd.). In addition, pore interval and pore depth were measured in the case of a mold body.

(Titration of Electrolytic Solution)

Aqueous oxalic acid solution used for anodic oxidation was diluted 25-fold and titrated with 0.1N aqueous sodium hydroxide solution using a titrator (Comtite-500, Hiranuma Sangyo Corp.) followed by measurement of pH.

### Example 1

A 0.3 M aqueous oxalic acid solution (aluminum concentration X₀: 0 ppm) was prepared and used as an electrolytic solution. The presence of a flat portion as shown in FIG. 1 was not confirmed when the aqueous oxalic acid solution was titrated.

After carrying out fabric polishing on a cylindrical aluminum base material free of roll marks and having an average crystal grain size of 40 μm obtained by carrying out forging treatment on an aluminum ingot having purity of 99.9% by weight and cutting to a diameter of 200 mm and length of 350 mm, the aluminum base material was imparted with a mirrored surface by subjecting to electrolytic polishing in a mixed solution of perchloric acid and ethanol (volume ratio: 1/4).

Step (a):

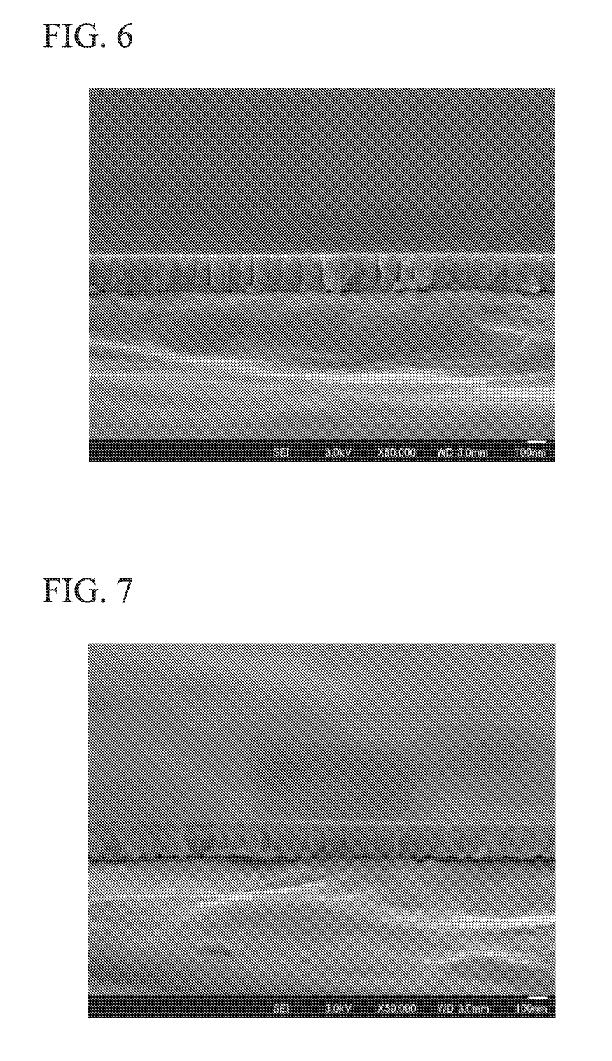

The mirror-polished aluminum base material was subjected to anodic oxidation for 30 minutes in a 0.3 M aqueous oxalic acid solution (aluminum concentration X₀: 0 ppm) under conditions of a direct current of 40 V and temperature of 16° C. The thickness of the oxide film at completion of step (a) was about 190 nm. A scanning electron micrograph of a cross-section of the resulting oxide film is shown in FIG. 6.

Step (b):

The aluminum base material having an oxide film formed thereon was immersed in a mixed solution of 6% by weight phosphoric acid and 1.8% by weight chromic acid for 2 hours to remove the oxide film.

Step (c):

The aluminum base material from which the oxide film had been removed was subjected to anodic oxidation for 30 seconds in a 0.3 M aqueous oxalic acid solution (same as that used in step (a)) under conditions of a direct current of 40 V and temperature of 16° C.

Step (d):

The aluminum base material on which the oxide film had been formed was subjected to pore diameter enlargement treatment by immersing for 8 minutes in a 5% by weight aqueous phosphoric acid solution at 30° C.

Step (e):

The aluminum base material subjected to pore diameter enlargement treatment was subjected to anodic oxidation for 30 seconds in a 0.3 M aqueous oxalic acid solution (that used in step (c) or a previous step (e)) under conditions of a direct current of 40 V and temperature of 16° C.

Step (f):

Step (d) and step (e) were repeated a total of four times after which step (d) was finally carried out to obtain a cylindrical mold body in which anodic alumina, having roughly conical pores of an average interval of 100 nm and depth of 200 nm, was formed on the surface thereof. The aluminum concentration X in the electrolytic solution was 5 ppm.

Step (g):

The mold body was immersed for 10 minutes in running water after having gently rinsed off aqueous phosphoric acid solution present on the surface of the mold body using a shower.

Step (h):

Air was blown onto the mold body from an air gun to remove water droplets adhered to the surface of the mold body.

Step (i):

The mold body was immersed for 10 minutes at room temperature in a solution obtained by diluting Optool DSX (Daikin Industries Ltd.) to 0.1% by weight with diluent HD-ZV (Harves Co., Ltd.).

Step (j): The mold body was slowly lifted out of the diluted solution at the rate of 3 mm/sec.

Step (k): The mold was air-dried overnight to obtain a mold treated with a mold release agent.

### Example 2

A piece of aluminum was immersed in a 0.3 M aqueous oxalic acid solution (aluminum concentration X₀: 0 ppm), and the aluminum was allowed to elute into the solution by allowing to stand undisturbed for a fixed period of time to prepare an aqueous oxalic acid solution having an aluminum concentration X of 500 ppm, or in other words, an aqueous oxalic acid solution equivalent to a fatigued solution resulting from anodic oxidation of a plurality of aluminum base materials. A flat portion as shown in FIG. 2 was confirmed when the aqueous oxalic acid solution was titrated.

A mold was obtained in the same manner as Example 1 with the exception of using this aqueous oxalic acid solution.

The thickness of the oxide film at completion of step (a) was about 190 nm. A scanning electron micrograph of a cross-section of the resulting oxide film is shown in FIG. 7.

A mold was obtained at completion of step (f) in which anodic alumina, having roughly conical pores of an average interval of 100 nm and depth of 200 nm, was formed on the surface thereof. The aluminum concentration X in the electrolytic solution was 5 ppm.

### Example 3

A piece of aluminum was immersed in a 0.3 M aqueous oxalic acid solution (aluminum concentration X₀: 0 ppm), and the aluminum was allowed to elute into the solution by allowing to stand undisturbed for a fixed period of time to prepare an aqueous oxalic acid solution having an aluminum concentration X of 600 ppm, or in other words, an aqueous oxalic acid solution equivalent to a fatigued solution resulting from anodic oxidation of a plurality of aluminum base materials. A flat portion was confirmed when the aqueous oxalic acid solution was titrated.

A mold was obtained in the same manner as Example 1 with the exception of using this aqueous oxalic acid solution.

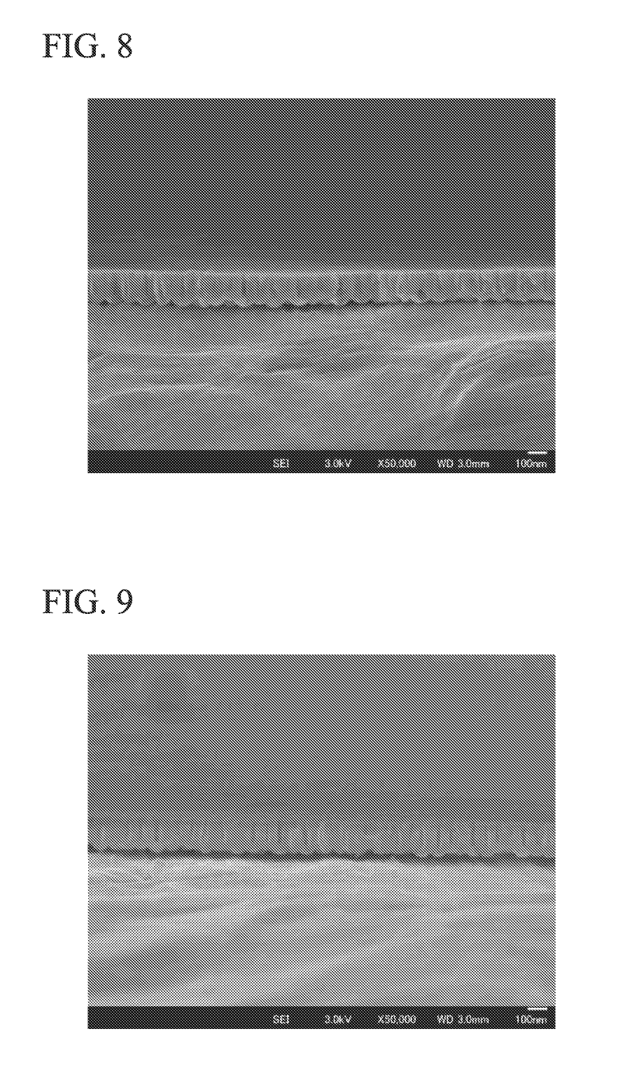

The thickness of the oxide film at completion of step (a) was about 190 nm. A scanning electron micrograph of a cross-section of the resulting oxide film is shown in FIG. 8.

A mold was obtained at completion of step (f) in which anodic alumina, having roughly conical pores of an average interval of 100 nm and depth of 200 nm, was formed on the surface thereof. The aluminum concentration X in the electrolytic solution was 5 ppm.

### Example 4

A piece of aluminum was immersed in a 0.3 M aqueous oxalic acid solution (aluminum concentration X₀: 0 ppm), and the aluminum was allowed to elute into the solution by allowing to stand undisturbed for a fixed period of time to prepare an aqueous oxalic acid solution having an aluminum concentration X of 800 ppm, or in other words, an aqueous oxalic acid solution equivalent to a fatigued solution resulting from anodic oxidation of a plurality of aluminum base materials. A flat portion was confirmed when the aqueous oxalic acid solution was titrated.

A mold was obtained in the same manner as Example 1 with the exception of using this aqueous oxalic acid solution.

The thickness of the oxide film at completion of step (a) was about 190 nm. A scanning electron micrograph of a cross-section of the resulting oxide film is shown in FIG. 9.

A mold was obtained at completion of step (f) in which anodic alumina, having roughly conical pores of an average interval of 100 nm and depth of 200 nm, was formed on the surface thereof. The aluminum concentration X in the electrolytic solution was 5 ppm.

### Comparative Example 1

A piece of aluminum was immersed in a 0.3 M aqueous oxalic acid solution (aluminum concentration X₀: 0 ppm), and the aluminum was allowed to elute into the solution by allowing to stand undisturbed for a fixed period of time to prepare an aqueous oxalic acid solution having an aluminum concentration X of 1005 ppm, or in other words, an aqueous oxalic acid solution equivalent to a fatigued solution resulting from anodic oxidation of a plurality of aluminum base materials. A flat portion as shown in FIG. 3 was confirmed when the aqueous oxalic acid solution was titrated.

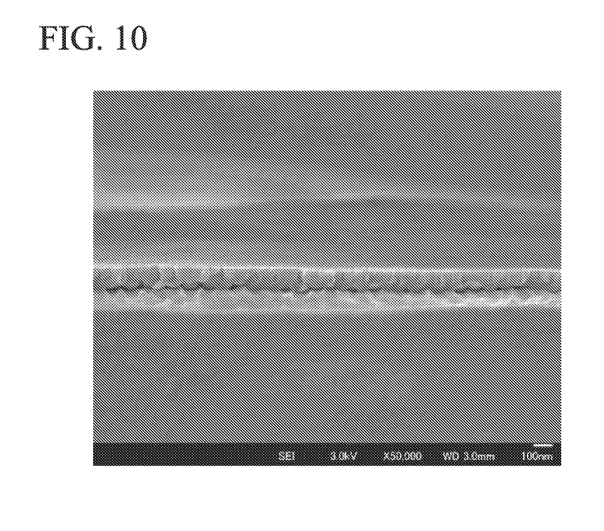

Step (a) was carried out in the same manner as Example 1 with the exception of using this aqueous oxalic acid solution. A scanning electron micrograph of a cross-section of the resulting oxide film is shown in FIG. 10.

The thickness of the oxide film at completion of step (a) was about 100 nm, and since the oxide film was thinner than the oxide films of the examples, production was discontinued since it was judged that a mold of a prescribed shape could not be produced.

### INDUSTRIAL APPLICABILITY

A mold obtained with the production method of the present invention is useful for efficient volume production of anti-reflective articles, anti-fogging articles, soil resistant articles and water-repellent articles.

### BRIEF DESCRIPTION OF THE REFERENCE SYMBOLS

10 Aluminum base material
12 Pores
14 Oxide film (anodic alumina)
18 Mold body (mold for nanoimprinting)

1. A method for producing m (where m is an integer of 1 or more) number of molds for nanoimprinting in which anodic alumina having a microrelief structure composed of a plurality of pores of a period equal to or less than the wavelength of visible light is formed on the surface of an aluminum base material, comprising:
one or more anodic oxidation steps for anodically oxidizing an aluminum base material in an electrolytic solution for each of m number of aluminum base materials, and
a difference (X−X₀) between the aluminum concentration X in the electrolytic solution and the aluminum concentration X₀ in the electrolytic solution immediately prior to the first anodic oxidation step of the first aluminum base material is 1000 ppm or less in all of the anodic oxidation steps.

2. The method for producing a mold for nanoimprinting according to claim 1, wherein m is an integer of 2 or more.

3. The method for producing a mold for nanoimprinting according to claim 1, wherein the electrolytic solution is an aqueous oxalic acid solution.

4. The method for producing a mold for nanoimprinting according to claim 3, wherein the aluminum concentration in the electrolytic solution is determined from the titrated amount of an aqueous alkaline solution in the flat portion of a titration curve that appears between a first equivalent point and a second equivalent point when the electrolytic solution has been titrated with the aqueous alkaline solution.

5. The method for producing a mold for nanoimprinting according to claim 4, wherein a calibration curve is prepared in advance between an aluminum concentration X′ and a titrated amount Y′ of an aqueous alkaline solution in the flat portion of a titration curve that appears between a first equivalent point and a second equivalent point when having titrated an aqueous oxalic acid solution having an aluminum concentration X′ with an aqueous alkaline solution having an alkaline concentration Z, and
the calibration curve is used to determine an aluminum concentration X in the electrolytic solution from a titrated amount Y of the aqueous alkaline solution in the flat portion of a titration curve that appears between a first equivalent point and a second equivalent point when the electrolytic solution has been titrated with an aqueous alkaline solution having an alkaline concentration Z.

6. (canceled)

7. The method for producing a film having a microrelief structure on a surface of the film with use of a mold for nanoimprinting produced by the method according to claim 1.

8. The method for producing a mold for nanoimprinting according to claim 1, wherein production of the mold for nanoimprinting is discontinued in case the difference (X−X₀) has exceeded 1000 ppm.

9. The method for producing a mold for nanoimprinting according to claim 1, wherein controlling the difference (X−X₀) to be 1000 ppm or less.

10. The method for producing a mold for nanoimprinting according to claim 2, wherein the number of m is 10 or more.
